(19) United States
(12) Patent Application Publication
(10) Pub. No.: US 2014/0291321 A1
(43) Pub. Date: Oct. 2, 2014

(54) STORAGE OR TRANSPORT CONTAINER FOR GASOLINE OR THE LIKE

(71) Applicant: Bernhard Schmid, Weinstadt (DE)

(72) Inventor: Bernhard Schmid, Weinstadt (DE)

(21) Appl. No.: 14/237,693

(22) PCT Filed: May 30, 2012
(86) PCT No.: PCT/EP2012/060140

§ 371 Date: Mar. 24, 2014

(30) Foreign Application Priority Data
Aug. 10, 2011 (DE) 10 2011 080 781.0

(51) Int. Cl. F17C 1/00; F17C 7/00

(52) U.S. Cl. CPC F17C 1/00; F17C 7/00
USPC 220/88.1; 222/383.1; 220/581; 222/333

(57) ABSTRACT

A storage or transport container for gasoline or similar hydraulic media, which tend to form explosive mixtures of air or gas and vapors. The container includes an electrically conductive plastic. The interior chamber of the container is substantially filled with an explosion-protection filling made of very highly thermally conductive material having a small displacement volume and a large surface.

### CROSS REFERENCE TO RELATED APPLICATIONS

This application is a U.S. National Phase Application of International Application PCT/EP2012/060140 filed May 30, 2012 and claims the benefit of priority under 35 U.S.C. §119 of German Patent Application DE 10 2011 080 781.0 filed Aug. 10, 2011, the entire contents of which are incorporated herein by reference.

### FIELD OF THE INVENTION

The invention relates to storage or transport containers for gasoline or similar hydraulic media, which tend to form explosive mixtures of air or gas and vapors.

### BACKGROUND OF THE INVENTION

According to the technical regulations for flammable liquids (TRbF20), the container openings of storage and transport containers for hydraulic media of the type described must be protected from flame penetration. For this purpose, flame arresters conforming to DIN EN 12874 are regularly required.

Such flame arresters may exceptionally be dispensed with if the construction of the container is sufficiently resistant to pressure shock and is thus able to withstand the pressure wave that accompanies an explosion.

As a consequence, containers for gasoline and the like are complicated to make, and therefore expensive, and in particular they cannot be designed as inexpensive plastic containers.

### SUMMARY OF THE INVENTION

The above is the starting point for the invention.

The invention is intended to solve the problem of producing safe, technically approvable containers for storing and transporting for gasoline and the like, made of plastic.

This problem is solved according to the invention in that the container wall essentially consists entirely of an electrically conductive plastic, and the interior chamber of the container is substantially filled with an explosion protection filling consisting of a very highly thermally conductive material with a small displacement volume and a large surface area.

The invention makes use of the insight, known per se, that a dangerous ignition of explosive gas or vapor mixtures can be prevented if the heat generated by an ignition is distributed and dissipated quickly. A bulk material consisting of agglomerated, mesh-like, expanded metal pieces of aluminum or the like, for example, may be provided as the explosion protection filling. Such explosion protection fillings are generally known, and may be used to render the storage tanks of military vehicles bulletproof, for example, but to date only a few civilian application possibilities have been suggested.

According to a modified embodiment of the invention, open-pored metal foams, of aluminum for example, may be provided instead of expanded metal clusters. Generally, however, explosion protection fillings consisting of non-metallic materials are also conceivable.

For example, the explosion protection filling may have the form of a crystal lattice-like network of carbon nanotubes or consist of corresponding bodies, which in turn may form a bulk material. Carbon nanotubes have good thermal conductivity, similar to that of diamonds, and therefore lend themselves particularly well to producing an explosion protection filling for a container. In addition, carbon nanotubes offer the advantage that gas-phase hydrocarbons tend to collect on the surface of the carbon nanotubes, with the advantageous consequence that when the container is opened only relatively small quantities of gas-phase hydrocarbons can escape.

In an expedient variation of the invention, provision may be made for arranging protective meshes on container openings, which may serve to safely prevent destructive access to the explosion protection filling or prevent parts of the explosion protection filling from falling out or being washed out.

The storage or transport container may also be provided with a tapping fitting and a pump, so that the reservoirs of petrol-driven implements, such as chainsaws for forestry applications, may be filled quickly and as required.

Thus, the invention further enables the provision of easily manageable mobile filling points for such devices.

For all mobile applications, the invention offers the particular advantage that the explosion protection filling effectively counteracts the slopping motion of the hydraulic medium transported in the tanks.

Otherwise, for the purpose of preferred features of the invention, reference is made to the claims and the following explanation of the drawing, which is used to describe a preferred embodiment of the invention in greater detail.

Protection is claimed not only for described or represented combinations of features but also for any and all theoretically possible combinations of the individual features described or represented.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic side view of a mobile transport container for petrol according to the invention.

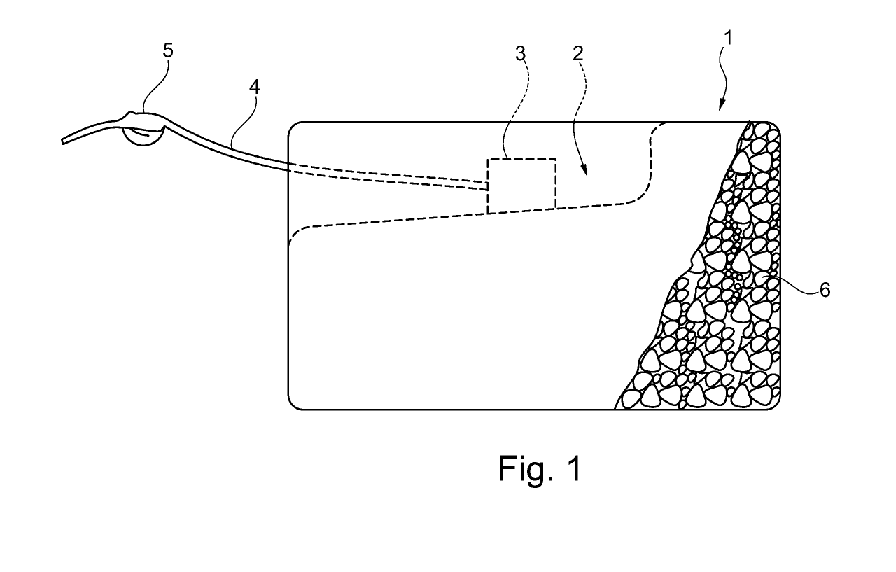

### DESCRIPTION OF THE PREFERRED EMBODIMENTS

Referring to the drawings in particular, container 1, which is shown in partial cutaway view, has a substantially cuboid shape, wherein a recess 2, open toward a narrow side of container 1, is provided in the top of the container and in which an electric or manually operated pump 3 with delivery pipe 4 and manual tapping fitting 5 is arranged or can be accommodated. The wall of container 1 is made from an electrically conductive plastic, which may be reinforced with glass fibers or the like.

The interior chamber of container 1 is substantially filled with an explosion protection filling 6, which in the example shown has the form of a bulk material consisting of gravel-like or bead-like bodies, which are in turn structured as agglomerated, mesh-like, expanded metal pieces of aluminum. Such bodies have extremely low displacement in the order of about 1% of the container volume and a very large surface area. The explosion protection effect is based mainly on the fact that due to its excellent thermal conductivity properties explosion protection filling 6 immediately dissipates heat generated at a given site and disperses it in a large volume, so that the ignition temperature required for an explosion is not reached or cannot be reached. The arrangement of baffles inside tank 1 is not necessary, since the explosion protection filling counteracts slopping movements very effectively.

Three-dimensional lattice-like networks of carbon nanotubes or bodies formed from such networks may be used for the explosion protection filling 6 instead of a mesh-like aluminum material. Carbon nanotubes have exceptionally good thermal conductivity capability, which is comparable to the thermal conductivity of diamond. Thus, such materials are particularly suitable for making the explosion protection filling. With regard to cost considerations, metal materials are currently preferred for the manufacturing the explosion protection filling.

Open-pored aluminum foams may also be used instead of mesh-like expanded metal aluminum fragments or the like.

While specific embodiments of the invention have been shown and described in detail to illustrate the application of the principles of the invention, it will be understood that the invention may be embodied otherwise without departing from such principles.

1. A storage or transport container for gasoline or similar hydraulic media, which tend to form explosive mixtures of air or gas and vapors the container comprising:
a wall consisting essentially of an electrically conductive plastic; and
an interior chamber of the container filled with an explosion protection material consisting of a very highly thermally conductive material with a small displacement volume and a large surface area.

2. The storage or transport container according to claim 1, wherein a bulk material consisting of agglomerated, mesh-like, expanded metal pieces of metal, is provided as the explosion protection filling.

3. The storage or transport container according to claim 1, wherein the explosion protection filling comprises open-pored metal foam bodies or one metal foam body.

4. The storage or transport container according to claim 1, wherein the explosion protection filling is at least partially structured as a three-dimensional lattice-like network of carbon nanotubes.

5. The storage or transport container according to claim 1, wherein:
the container has an opening; and
protective meshes are arranged on the container opening, to protect the explosion protection filling from damage or removal.

6. The storage or transport container according to claim 1, wherein the container is equipped with an electrically or manually operable pump and a delivery pipe with manual dispensing nozzle connected thereto.

7. The storage or transport container according to claim 1, wherein a bulk material consisting of agglomerated, mesh-like, expanded metal pieces of aluminum, is provided as the explosion protection filling.

8. The storage or transport container according to 7, wherein the explosion protection filling comprises open-pore aluminum foam bodies or a single open-pore aluminum foam body.

9. The storage or transport container according to claim 1 wherein the explosion protection filling comprises a body formed of a three-dimensional lattice network of carbon nanotubes.

10. The storage or transport container according to claim 2 wherein:
an opening is formed in the wall; and
protective meshes are arranged at or adjacent to the opening to protect the explosion protection filling from damage or removal.

11. The storage or transport container according to claim 3 wherein:
an opening is formed in the wall; and
protective meshes are arranged at or adjacent to the opening to protect the explosion protection filling from damage or removal.

12. The storage or transport container according to claim 4 wherein:
an opening is formed in the wall; and
protective meshes are arranged at or adjacent to the opening to protect the explosion protection filling from damage or removal.

13. A storage or transport container for hydraulic media which may form explosive mixtures of air or gas and vapor, the container comprising:
a wall comprising an electrically conductive plastic, the wall defining an interior chamber; and
an explosion protection material filling within the chamber, the filling comprising a very highly thermally conductive material with a small displacement volume and a large surface area.

14. The storage or transport container according to claim 13, wherein the filling consists of agglomerated, mesh, expanded metal pieces.

15. The storage or transport container according to claim 13, wherein the filling comprises an open-pore metal foam body.

16. The storage or transport container according to claim 13 wherein the filling comprises a three-dimensional lattice network of carbon nanotubes.

17. The storage or transport container according to claim 13 wherein:
an opening is formed in the wall; and
a protective mesh is arranged at or adjacent to the opening to protect the explosion protection filling from damage or removal through the opening.

18. The storage or transport container according to claim 13, further comprising an electrically or manually operable pump and a delivery pipe with manual dispensing nozzle connected to the pump.
